(19) United States
(12) Patent Application Publication
(10) Pub. No.: US 2023/0271447 A1
(43) Pub. Date: Aug. 31, 2023

(54) GREASE CAP FOR BEARINGS

(71) Applicant: Valcrum LLC, Cypress, TX (US)

(72) Inventor: Mario T. Robles, JR., Cypress, TX (US)

(73) Assignee: Valcrum LLC, Cypress, TX (US)

(21) Appl. No.: 18/173,556

(22) Filed: Feb. 23, 2023

Related U.S. Application Data
(60) Provisional application No. 63/268,565, filed on Feb. 25, 2022.

(51) Int. Cl. B60B 27/00; F16B 7/02

(52) U.S. Cl. CPC B60B 27/0047; F16B 7/025; B60B 2900/5112

(57) ABSTRACT

A hub mounted grease cap having a sleeve with an inner end and an outer end. The outer end has an outer end surface that is opposite the inner end. The sleeve encloses a bore that extends through the sleeve. The inner end has an outer diameter that may be a press fit or threaded connection to a hub into which it is installed. An end plug has an end wall and an aperture through the end wall. There is a shaft that extends through the aperture in the end wall of the end plug. A wedge block is connected to the shaft. A seal has a portion that is located between the end wall of the end plug and the wedge block. The seal expands radially outward against the bore of the sleeve when the wedge block is drawn toward the end wall.

### CROSS REFERENCE TO RELATED APPLICATIONS

This application claims priority of U.S. Provisional application 63/268,565, filed Feb. 25, 2022, which application is hereby incorporated in its entirety by reference.

### BACKGROUND OF THE INVENTION

Having properly lubricated trailer bearings is critical to their function. Traditionally, maintaining proper lubrication to trailer bearings has been done very poorly with grease caps. The grease caps that are frequently used for this purpose work poorly to keep the grease in place on the bearings and protect the grease from contamination. Both of these functions are critical to having properly lubricated bearings.

Traditionally, grease caps rely on a machined counterbore on the hub into which the bearings are placed. The grease cap is then pressed into the counterbore with a matching outer diameter. The metal-on-metal press fit is the only seal that prevents water or other contaminants from entering the hub and the bearings. While it may be possible to have a perfect fit at the connection of the grease cap outer diameter and the corresponding counterbore in the hub, there is certainly ample opportunity for an imperfection in either part to provide a leak path that is detrimental to the bearings.

In the event a user of the trailer wishes to inspect the bearings, that task is made difficult by the present system. Inspecting the bearings requires a user pry the existing cap out of the counterbore. That task is often accomplished with a flat head screwdriver if an adequate shoulder is present near the counterbore. In other cases, a user may use a hammer to tap the sides of the grease cap until it falls out of the counterbore on the hub. In either case, this can cause damages to the grease cap because removal by either means can damage the outer diameter that interfaces with the counterbore. If a grease cap is damaged by the manner of its removal, simply reinstalling it will certainly cause problems later. The difficulty of removal for current grease caps makes them somewhat one use items and certainly limits the number of times they may be reused. As such, current grease caps provide a built-in disincentive to inspect and maintain trailer bearings. Thus, an improved system is needed.

### SUMMARY OF THE INVENTION

A hub mounted grease cap that has a sleeve with an inner end and an outer end. The outer end has an outer end surface that is opposite the inner end. The inner end has an outer diameter and the sleeve encloses a bore that extends through the sleeve. An end plug has an end wall and an aperture through the end wall. There is a shaft that extends through the aperture in the end wall of the end plug. A wedge block is connected to the shaft. A seal has a portion that is located between the end wall of the end plug and the wedge block. The seal expands radially outward against the bore of the sleeve when the wedge block is drawn toward the end wall.

### BRIEF DESCRIPTION OF THE DRAWINGS

FIG. 1 is an isometric view of the grease cap of the present invention;

FIG. 2 is a sectional view of the grease cap shown in FIG. 1 through the center of the grease cap;

FIG. 2B is a magnified view showing area 2B in FIG. 2 showing the annular seal in its uncompressed state;

FIG. 2C is a magnified view showing the same area as in FIG. 2B with the annular seal in its compressed state;

FIG. 3 is an isometric view of the sleeve of the grease cap shown in FIGS. 1 and 2;

FIG. 4 is a sectional vies of the sleeve shown in FIG. 3 through the center of the sleeve;

FIG. 5 is an isometric view of the end plug shown installed into the sleeve in FIG. 1;

FIG. 6 is an isometric view showing the grease cap with a hub odometer attached to the end plug;

FIG. 7 is a sectional view of an end plug having a wedge block having a groove and the wedge block having retention to the end plug;

FIG. 7B is a magnified view showing area 7B in FIG. 7 showing the annular seal in its uncompressed state;

FIG. 7C is a magnified view showing the same area as in FIG. 7B showing the annular seal in its compressed state;

FIG. 8 is a sectional view of the end plug shown in FIG. 7;

FIG. 8B is a magnified view showing area 8B in FIG. 8 showing how the retention prongs secure the wedge block when the seal is in its uncompressed state;

FIG. 8C is a magnified view showing the same area as in FIG. 8B showing the retention prongs with respect to the wedge block when the seal is in its compressed state;

FIG. 9 is an isometric view of the wedge bloc in FIGS. 7 and 8 showing the side facing the end plug; and

FIG. 10 is the end plug shown in FIGS. 7 and 8 separated from the wedge block.

### DETAILED DESCRIPTION OF INVENTION

The hub mounted grease cap 10 is for mounting into a hub 16 that holds bearings. The hub 16 has a counterbore 20 that receives the grease cap 10 to enclose a grease chamber 21. The grease cap 10 has a sleeve 28 having an inner end 32 and an outer end 36. The inner end 32 has an outer diameter 38 that has an elastomeric insert 40 having a series of elastomeric redundant rings 44. It is also contemplated that the outer diameter 38 may be threaded and not include an elastomeric insert 40 for certain applications where the hub 16 is adapted to receive a threaded grease cap (which is not shown). The elastomeric insert 40 is molded onto the inner end of the sleeve 28. The elastomeric redundant rings 44 act as a sealing feature between the counterbore 20 of the hub 16 and the sleeve 28. It is contemplated that the elastomeric insert 40 could also be flat along its outer diameter 38. The elastomeric insert 40 provides a secure grip within the counterbore 20 as well as a watertight seal that is not available using a metal-on-metal connection as has been traditionally done. This is particularly better than a metal-on-metal connection within the counterbore 20 when the inevitable scratches occur within the counterbore 20.

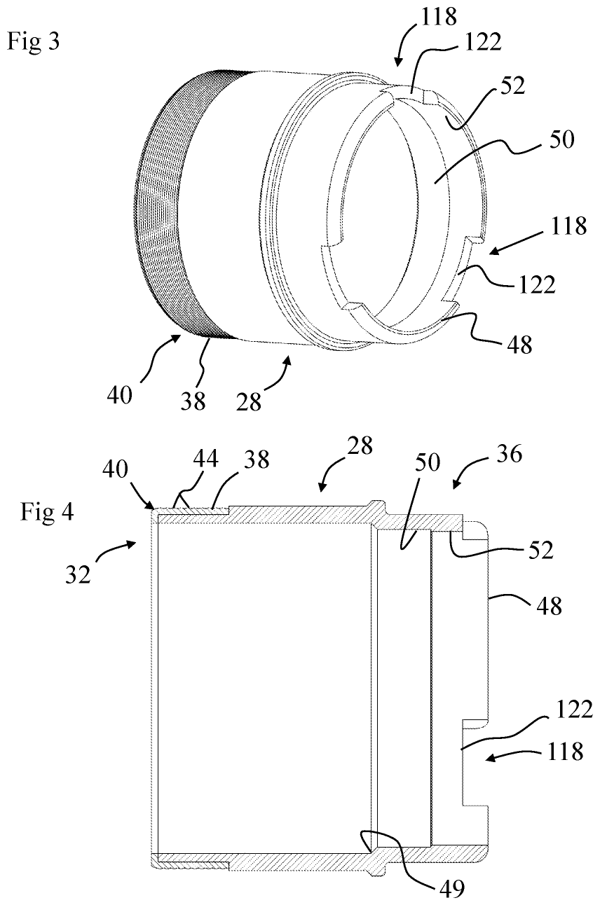

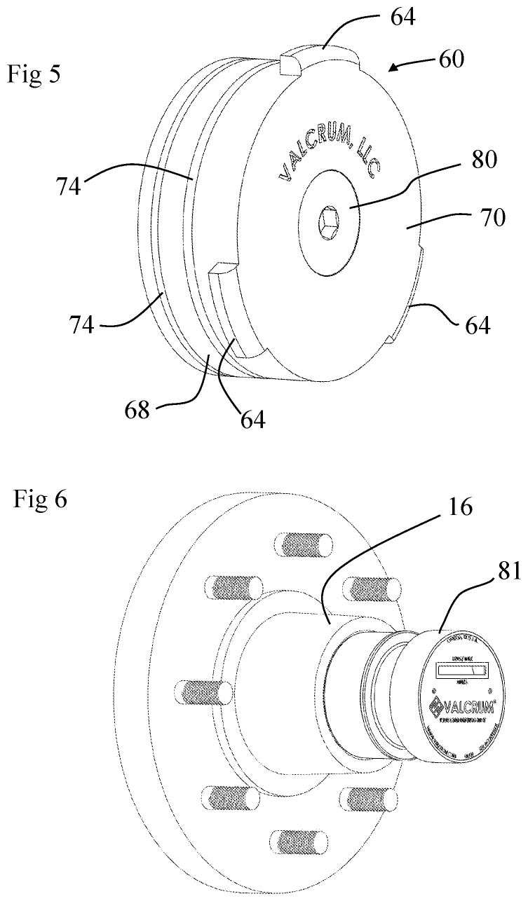

The outer end 36 of the sleeve 28 has an outer end surface 48 defining the end of the sleeve 28. Near the outer end 36 there is a first inner diameter 50 and a second inner diameter 52. The first inner diameter 50 is offset from the outer end surface 48 and is nearer the inner end 32. The second inner diameter 52 extends from the outer end surface 48 to a shoulder 49 that defines a stepped transition from the second inner diameter 52 to the first inner diameter 50. The first inner diameter 50 is larger than the second inner diameter 52. The shoulder 49 is typically a sharp transition and may be a 45-degree chamfer that serves as a transition between the first inner diameter 50 and the second inner diameter 52. FIG. 4 shows the shoulder 49.

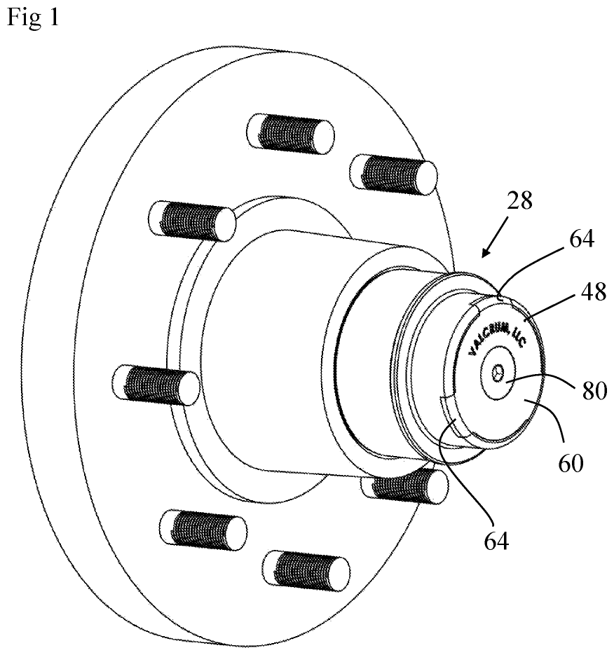

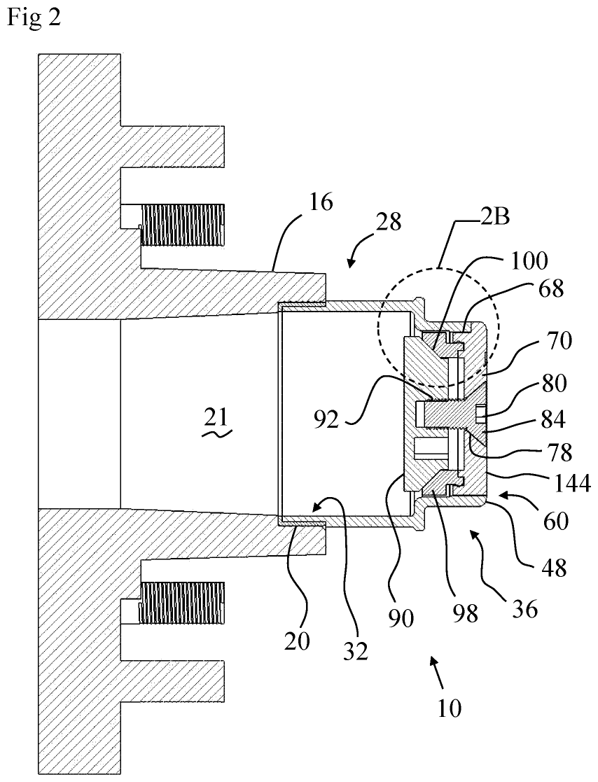

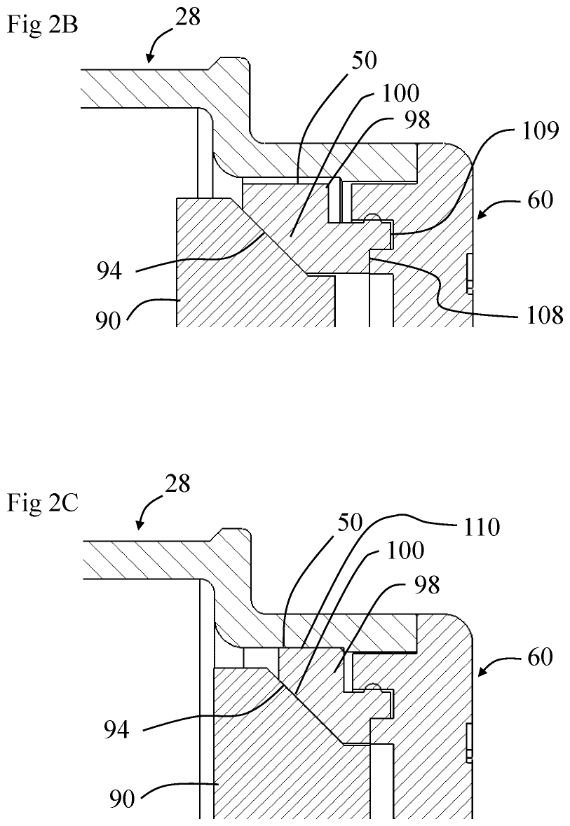

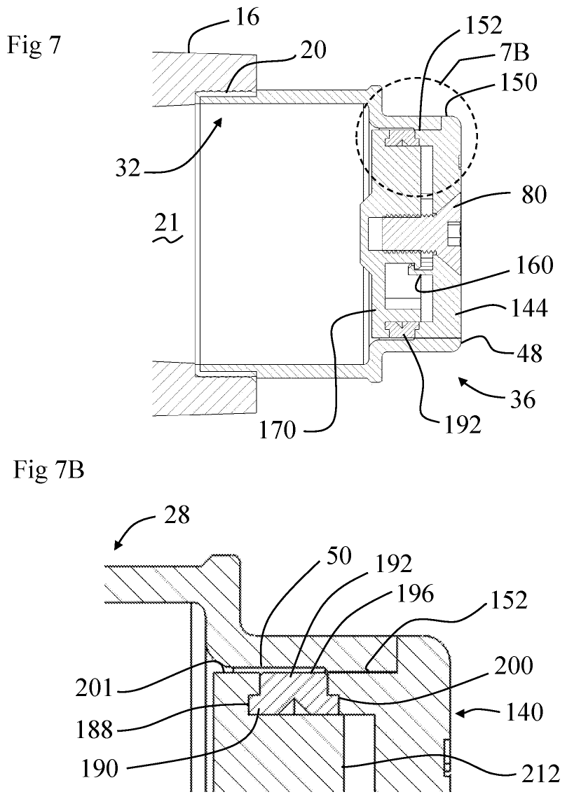

An end plug 60 is for fitting into the outer end 36 of the sleeve 28. The end plug 60 is shown in FIG. 1 and is shown in the sectional view of FIG. 2. The end plug 60 has three tabs 64 that extend outwardly from a pilot diameter 68. The tabs 64 are connected to an end wall 70. The pilot diameter 68 may have grooves 74 for receiving seals (not shown) that may contact the second inner diameter 52 of the sleeve 28 when the end plug 60 is inserted into the sleeve 28. FIG. 2 shows the end plug 60 inserted into the outer end 36 of the sleeve 28. The end wall 70 has an aperture 78 that extends through the end wall 70. The aperture 78 is for receiving a screw 80 which is free to rotate within the aperture 78. The aperture 78 is a clearance hole for the threaded portion 82 of the screw 80. The head 84 of the screw 80 is larger than the aperture 78 so that the screw 80 may not pass through the aperture 78. Although the head 84 of the screw 80 is shown as a countersunk style, it could be a hex head or other type of head that stands outwardly of the end wall 70. Further, it is contemplated that the head 84 of the screw 80 could be used as an anchor upon which to fasten other objects. For instance, a hub odometer 81 may be such a device mounted to the head 84 of the screw 80, as shown in FIG. 6.

The screw 80 extends into a wedge block 90. The wedge block 90 has a threaded hole 92 to mate with the threaded portion 82 of the screw 80. The wedge block 90 is spaced inwardly from the end wall 70 of the end plug as seen in FIG. 2. The wedge block 90 has an inclined surface 94 that acts as a compression surface for contacting an annular seal 98 that is located adjacent to the inclined surface 94. The annular seal 98 is an elastomeric seal that circumscribes the wedge block 90. The annular seal 98 has a mating inclined surface 100 for contacting the inclined surface 94 of the wedge block 90. The inclined surface 100 of the annular seal 98 acts as a compression surface to receive force from the wedge block 90. Opposite the inclined surface 100 on the annular seal 98 is an outer compression surface 108 that is on the annular seal 98. The outer compression surface 108 is for abutting the end wall 70 of the end plug 60. The outer compression surface 108 also includes annular rib 109 that assists with concentric alignment of the annular seal 98 with respect to the pilot diameter 68 of the end plug 60 when the annular seal 98 is held against the end wall 70 of the end plug 60. As the screw 80 is turned in the aperture 78 extending through the end wall 70 in its tightening direction, the screw 80 draws the wedge block 90 toward the end wall 70. As this occurs, the wedge block 90 compresses the annular seal 98 between the inclined surface 94 and the end wall 70. Due to the elastomeric nature and resilience of the annular seal 98, drawing the wedge block 90 toward the end wall 70 causes the annular seal 90 to expand outwardly. When the outer diameter 110 of the annular seal 98 is in an uncompressed state, it is spaced out from the first inner diameter 50. This is shown in more detail in FIG. 2B. As the screw 80 is tightened, the outer diameter 110 expands to press against the first inner diameter 50 in a tight fitting compressed state. This is shown in FIG. 2C. As such, the friction of the expanded outer diameter 110 of the annular seal 98 against the first inner diameter 50 acts to hold the entire end plug 60 onto the sleeve 28. Additionally, the outer diameter 110 of the annular seal 98 impinges on the shoulder 49 when the outer diameter 110 is expanded. This impingement on the shoulder 49 is because the outer diameter 110 of the seal 98 expands to the full size of the first inner diameter 50, which is larger than the second inner diameter 52. As such, the annular seal 98 and wedge block 90 are fixed with respect to the sleeve 28 and the end plug 60 is held in place with screw 80. This corresponds to a set state of the hub mounted grease cap 10 that keeps the entire grease cap 10 sealed with respect to the environment outside of the hub 16 in which the grease cap 10 is inserted. In addition to the sealed connection of the annular seal 98 upon the first inner diameter 50, seals held in grooves 74 in the pilot diameter 68 may provide additional sealing against the second inner diameter 52.

As the screw 80 is turned, it may impart rotation on the entire end plug 60 with respect to the sleeve 28. To prevent rotation of the end plug 60 with respect to the sleeve 28, the tabs 64 are inserted into notches 118 that interrupt the outer end surface 48. The notches 118 have a bottom surface 122 that is offset from the outer end surface to a particular depth. As shown in FIG. 1, the end plug 60 may be inserted into the sleeve 28 so that the tabs 64 seat in the notches 118, leaving the end plug 60 flush with the outer end surface 48. When the tabs 64 are inserted into the notches 118, rotation of the end plug 60 with respect to the sleeve is prevented so that the screw 80 may be turned without turning the end plug 60. The tabs 64 are also used to set the appropriate depth of the end plug 60 so that the annular seal 98 is located adjacent to the shoulder 49 in its uncompressed state. The inclined surface 94 on the wedge block 90 serves a centering function for the annular seal 98 so that when it is uncompressed, it may pass easily through the second inner diameter 52.

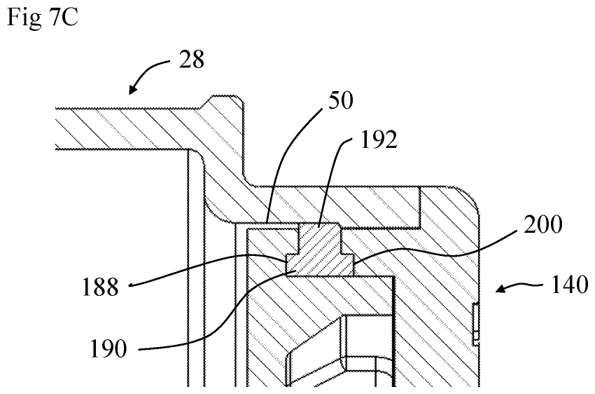

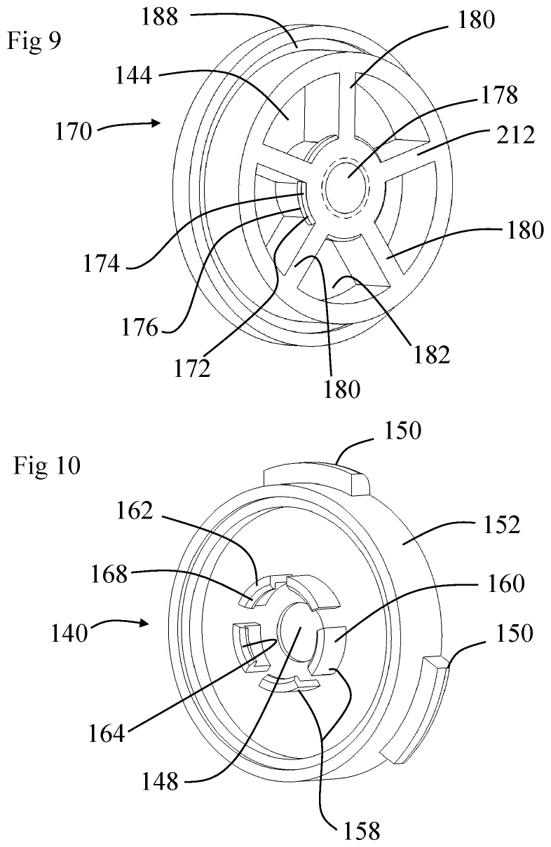

End plug 140 may also be used instead of the previously described end plug 60. End plug 140 is shown in FIG. 7B, 7C and 8. End plug 140 works on the same principle as end plug 60, but has slightly different features to serve its function as well as additional desirable features that enhance its utility. End plug 140 has an end wall 144 with an aperture 148 that holds a screw 80. Aperture 148 is a clearance hole for the screw 80 inserted therein as discussed above so that the screw 80 may rotate freely within aperture 148. FIG. 10 shows the inner side of the end plug 140. Tabs 150 extend outwardly of pilot diameter 152 and serve the same anti-rotation function as tabs 64. As seen in FIG. 10, the inner side of the end wall 144 includes retention prongs 158 that have an upstanding wall 160 and an overhanging wall 162. The overhanging wall 162 includes a catch surface 164 that faces the end wall 144 and is oppositely spaced from the end wall 144. The opposite side of the overhanging wall 162 includes an inclined surface 168. The upstanding walls 160 of the retention prongs 158 are cantilevered with respect to the end wall 144 so they may resiliently flex in a radially outward direction and be biased inward toward their unflexed position shown in FIG. 10.

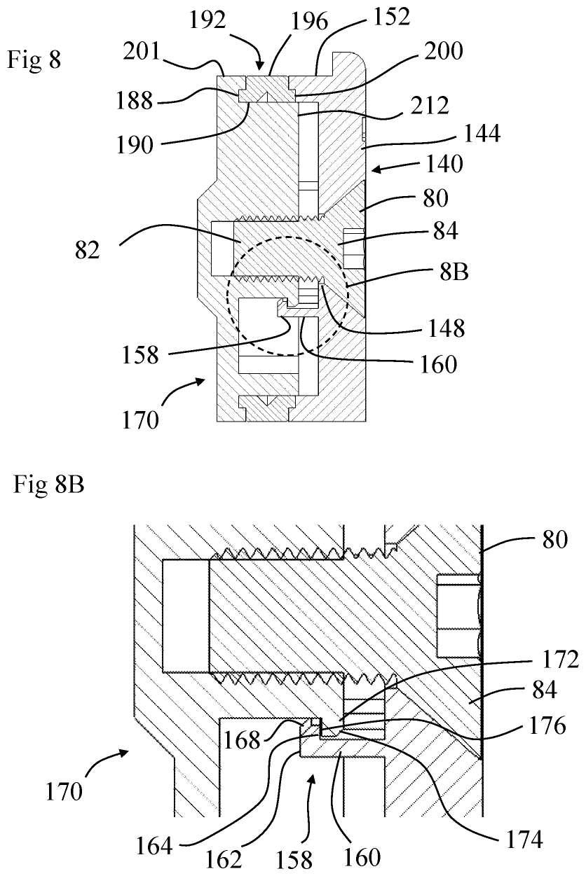

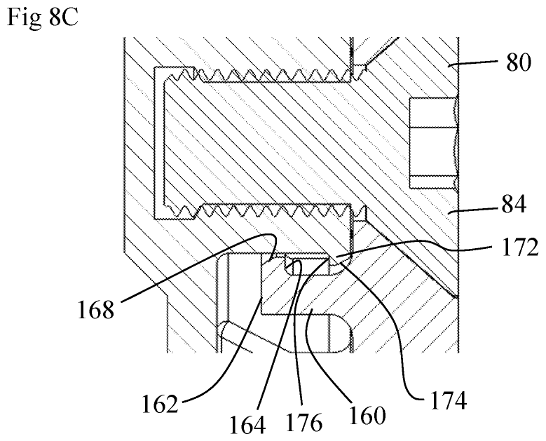

End plug 140 is mateable with wedge block 170. Wedge block 170 includes a radial retention wall 172 having an inclined surface 174 that is opposite a catch surface 176. The catch surface 176 is spaced from the end wall 144. The radial retention wall 172 extends outwardly of a threaded hole 178 that receives screw 80. Wedge block 170 has a series of ribs 180 that separate pockets 182 that are for receiving the retention prongs 158. When the wedge block 170 is pushed onto the retention prongs 158 so the retention prongs 158 are in the pockets 182, the wedge block 170 is slidingly retained upon the end plug 140. This is easily done because the retention prongs 158 are bent radially outward as the inclined surface 174 of the radial retention wall 172 pushes against the inclined surface 168 of each retention prong 158 as they are pressed into each other. Once the catch surface 164 of each retention prong 158 passes the catch surface 176 of the radial retention wall 172, each retention prong 158 snaps back to its unflexed position as shown in FIG. 10. The maximum distance that the wedge block 170 may be spaced from the end plug 140 is defined by the location where the catch surface 164 of each retention prong 158 contacts the catch surface 176 of the radial retention wall 172. This maximum distance of the wedge block 170 may be spaced from the end plug 140 when they are joined is shown in FIGS. 7 and 8. When the end plug 140 is joined to the wedge block 170, removal of the screw 80 will not separate the two parts because the retention prongs 158 will hold them together.

The wedge block 170 includes a groove 188 that is offset radially inward of the pilot diameter 152. Groove 188 serves as an undercut for receiving a wide portion 190 of an annular seal 192 having an outer diameter 196. The end plug 140 has an undercut 200 offset radially inward of the pilot diameter 152. The outer diameter 201 of the wedge block 170 is the same as the pilot diameter 152 of the end plug 140. The groove 188 and undercut 200 are radially equidistant from the center of the pilot diameter 152 and serve to capture the wide portion 190 of the annular seal 192. The wide portion 190 of the annular seal 192 is completely captured between the wedge block 170 and end plug 140 because end surface 212 of the wedge block 170 extends beyond the lateral depth of undercut 200 when the wedge block 170 is held by the retention prongs 158 in its farthest location from the end plug 140. FIGS. 7B and 8 show this relationship because end surface 212 of the wedge block extends laterally beyond the bottom of undercut 200. As the screw 80 is tightened, the wedge block 170 is drawn nearer the end plug 140. As this occurs, the outer diameter 196 of the annular seal 192 expands outwardly. This happens because the volume of the space between the groove 188 and undercut 200 decreases as the wedge block 170 is drawn toward the end plug 140. It should be noted that this function of expanding the outer diameter 196 of the annular seal 192 could be accomplished by any style of undercut between the wedge block 170 and end plug 140 that decreases in volume as the screw 80 is tightened. It is contemplated that the volume defined by the groove 188, the undercut 200 and the wedge block 170 could be a different shape than that shown in FIG. 7B and still serve the same purpose of having the annular seal 192 expand radially outwardly as a differently shaped wedge block (not shown) is drawn toward the end plug 140. It is also contemplated that the wedge block 170 could be a flat face abutting a flat end wall and through the force of being drawn toward a flat end wall cause a seal therebetween to expand. The space containing the wide portion of the annular seal 192 between the wedge block 170 and the end plug 140 provides a predictable concentric location of the outer diameter 196 of the annular seal 192 with respect to the pilot diameter 152. This allows the outer diameter 196 of the annular seal 192 to be easily inserted through the second inner diameter 52 before the annular seal 192 is expanded by tightening the screw 80. The end plug 140 is prevented from rotating with respect to the sleeve 28 by its tabs 150 which interlock into notches 118 in the sleeve 28 and the wedge block 170. This prevents rotating with respect to the end plug 140 by the retention prongs 158 contacting ribs 180 when the retention prongs 158 are inserted into the pockets 182.

The invention is not limited to the details described in the specification, but may be modified within the scope of the following claims.

What is claimed is:

1. A hub mounted grease cap comprising:
a sleeve having an inner end, an outer end opposite said inner end, said inner end having an outer diameter and said outer diameter having a sealing feature on said outer diameter, said outer end including an outer end surface a first inner diameter and a second inner diameter, said first inner diameter being nearer said inner end than said second inner diameter, said second inner diameter being located adjacent to said outer end, said first inner diameter being larger than said second inner diameter to define a shoulder, said outer end surface including a notch extending toward said inner end;
an end plug having an end wall and a pilot diameter, said end wall having an aperture therethrough and said end plug having a tab extending therefrom, said tabs for fitting into said notch and preventing rotation of said end plug with respect to said sleeve when said end plug is inserted into said sleeve;
a threaded fastener;
a wedge block having a threaded hole for receiving said threaded fastener, said wedge block being spaced from said end wall of said end plug, said wedge block having an annular inclined surface, said threaded fastener drawing said wedge block toward said end wall of said end plug when said threaded fastener extends through said aperture of said end wall and said threaded fastener is turned within said threaded hole of said wedge block in a tightening direction of said threaded fastener;
an annular seal having a portion located between said end wall and said wedge block, said annular seal contacting said annular inclined surface and said wedge block expanding said seal radially outward against said first inner diameter when said threaded fastener is turned in said tightening direction and thereby drawing said wedge block nearer said end wall.

2. The hub mounted grease cap of claim 1, wherein said pilot diameter includes a sealing feature for sealing against said second diameter.

3. The hub mounted grease cap of claim 1, wherein said end wall includes an antirotation feature extending toward said wedge block and preventing relative rotation of said wedge block with respect to said end plug.

4. The hub mounted grease cap of claim 1, wherein said seal includes an inclined surface, said annular inclined surface of said wedge block mateable with said inclined surface of said seal when said seal is located between said end wall and said wedge block.

5. A hub mounted grease cap comprising:
a sleeve having an inner end, an outer end opposite said inner end, said inner end having an outer diameter, said outer end including an outer end surface a first inner diameter and a second inner diameter, said first inner diameter being nearer said inner end than said second inner diameter, said second inner diameter being located adjacent to said outer end, said first inner diameter being larger than said second inner diameter to define a shoulder where said first and second inner diameters meet,
an end plug having an end wall, said end wall having an aperture therethrough;
a threaded fastener;
a wedge block having a threaded hole for receiving said threaded fastener, said wedge block being spaced from said end wall of said end plug, said threaded fastener drawing said wedge block toward said end wall of said end plug when said threaded fastener extends through said aperture of said end wall and said threaded fastener is turned within said threaded hole of said wedge block in a tightening direction of said threaded fastener;
a seal having a portion located between said end wall of said end plug and said wedge block, said seal expanding radially outward against said first inner diameter when said threaded fastener is turned in said tightening direction and thereby drawing said wedge block nearer said end wall.

6. The hub mounted grease cap of claim 5, wherein said pilot diameter includes a sealing feature for sealing against said sleeve.

7. The hub mounted grease cap of claim 5, wherein said end plug includes an anti-rotation feature for mating with a feature on said sleeve to prevent rotation of said end plug when said end plug is inserted into said sleeve.

8. The hub mounted grease cap of claim 7, wherein said anti-rotation feature is a tab extending from said end plug for fitting into a notch of within said sleeve.

9. The hub mounted grease cap of claim 8, including a plurality of tabs for fitting into a plurality of notches within said sleeve.

10. The hub mounted grease cap of claim 5, wherein said wedge block includes an annular inclined surface, a portion of said seal contacting said annular inclined surface.

11. The hub mounted grease cap of claim 10, wherein said seal includes an inclined surface, said inclined surface of said seal contacting said annular inclined surface of said wedge block.

12. The hub mounted grease cap of claim 5, wherein said outer diameter includes a sealing feature on said outer diameter.

13. A hub mounted grease cap comprising:
a sleeve having an inner end, an outer end surface opposite said inner end, said inner end having an outer diameter, said sleeve enclosing a bore extending through said sleeve;
an end plug having an end wall and an aperture through said end wall;
a shaft;
a wedge block being connected to said shaft and said shaft extending through said aperture in said end wall;
a seal having a portion located between said end wall of said end plug and said wedge block, said seal expanding radially outward against said bore of said sleeve when said wedge block is drawn toward said end wall.

14. The hub mounted grease cap of claim 13, wherein said shaft is a threaded shaft of a screw having a head, said wedge block having a threaded hole for receiving said shaft of said screw and rotation of said screw within said threaded hole of said wedge block in a tightening direction drawing said wedge block nearer said end wall.
